(19) United States
(12) Patent Application Publication
(10) Pub. No.: US 2016/0147415 A1
(43) Pub. Date: May 26, 2016

(54) PROGRAMMING SYSTEM FOR A SITUATION ANALYSIS SYSTEM ON BOARD A CARRIER COMPRISING AT LEAST ONE ONBOARD LISTENING SYSTEM

(71) Applicant: THALES, NEUILLY SUR SEINE (FR)

(72) Inventors: OLIVIER GRISVARD, ELANCOURT (FR); ERIC LE PORS, ELANCOURT (FR); PIERRE LABORDE, ELANCOURT (FR); JEAN-MICHEL EUSTACHE, ELANCOURT (FR)

(21) Appl. No.: 15/011,305

(22) Filed: Jan. 29, 2016

Related U.S. Application Data
(63) Continuation of application No. PCT/FR2014/066512, filed on Jul. 31, 2014.

(30) Foreign Application Priority Data
Aug. 1, 2013 (FR) 13 01853

(51) Int. Cl. G06F 3/0484; G06F 3/0488; G06F 3/0481

(52) U.S. Cl. CPC G06F 3/04842; G06F 3/04817; G06F 3/0488

(57) ABSTRACT

A programming system for a situation analysis system on board a carrier including at least one onboard listening system is disclosed. In one aspect, the system includes an operating terminal including an information display. The display includes a first portion for displaying tactical data on the environment of the carrier and a second portion for displaying assistance in adjusting the operating parameters of at least one onboard listening system. The programming system includes a capability for an operator to select at least one object of interest on the first display portion and a capability for automatically adjusting operating parameters of the least one onboard listening system on the selected object(s) of interest.

### CROSS-REFERENCE TO RELATED APPLICATIONS

This application is a continuation of International Application No. PCT/EP2014/066512, filed Jul. 31, 2014, which claims benefit under 35 U.S.C. §119 of French Application No. 13 01853, filed Aug. 1, 2013, which is herein incorporated by reference in its entirety.

### BACKGROUND

1. Technological Field

The described technology generally relates to a programming system for a situation analysis system onboard a carrier comprising at least one onboard listening system and an associated method for programming a situation analysis system onboard a carrier.

2. Description of the Related Technology

The described technology falls within the field of man-machine interaction methods, adapted for configuring mission systems, in particular in a restricted environment.

A mission system allows one or more operators to carry out a given mission, for example an environment surveillance, reconnaissance or combat mission, using a situation analysis system including various sensors (e.g., radars, cameras, detectors) and/or effectors (e.g., scramblers, decoys). In general, passive sensors and effectors are designated as listening systems. The mission system aggregates information provided by the various listening systems, to provide a synthesized vision to the operator, via a man-machine interface (MMI). Furthermore, the operator is led to adjust a set of parameters relative to the sensors and/or effectors and to select types of metadata to be displayed, via the man-machine interface.

Such mission systems are in particular intended to be onboard a carrier (e.g., aircraft, land vehicle, vessel). Consequently, the use of such a mission system is highly constrained by the environment, in particular with abrupt movement phenomena, major vibrations, high ambient noise or low or strong brightness, depending on the case.

It is difficult to design a man-machine interface suitable for such usage conditions, and in particular for programming onboard listening systems.

### SUMMARY OF CERTAIN INVENTIVE ASPECTS

The existing man-machine interfaces for mission systems are generally made up of one or more screens, a keyboard and a trackball, sunk into a console fixed to the structure of the carrier in order to limit movements and vibrations. The trackball offers the same capabilities as a computer mouse, but in a fixed position, and has greater inertia than a mouse in order to avoid autonomous movements without action by the operator. Due to this inertia, moving a pointer on the screen by actuating the trackball requires a substantial effort to achieve average precision in case of abrupt movements or strong vibrations of the carrier. Furthermore, the configuration of the analysis system for complex objects characterized by a large number of parameters could take a long time, which is detrimental in an operational mission.

There is therefore a need to improve the programming of onboard listening systems in order to facilitate the entry and update of complex parameters.

To that end, one inventive aspect is a system for programming a situation analysis system onboard a carrier comprising at least one onboard listening system, including an operating terminal comprising an information display capability. In the programming system, the display capability comprises a first portion for displaying tactical data on the environment of the carrier and a second portion for displaying assistance in adjusting the operating parameters of at least one onboard listening system, the programming system including a capability for an operator to select at least one object of interest on the first display portion and a capability for automatically adjusting operating parameters of the least one onboard listening system on the selected object(s) of interest.

Advantageously, the programming system allows an easy adjustment of the parameters with respect to objects of interest relative to the selected tactical environment data, the separation of the display capability into a first display portion for tactical data and a second display portion intended for adjusting the operating parameters making it possible to improve the ergonomics of the interface of the terminal.

Another aspect may include one or more of the features below, considered alone or in combination:
the display capability is formed by at least one touchscreen and the selection is done by the operator by pressing a finger on the object of interest of the first tactical data display portion and sliding a finger toward the second display portion, in order to initiate a display, in the second portion, of graphic objects making it possible to adjust the operating parameters of at least one onboard listening system based on the object of interest;
the system is able to display, in the first display portion, a set of tactical data in the form of objects of interest represented in a hierarchical tree structure;
the system is able to display, in the first display portion, a list of selectable objects, filtered as a function of tactical data categories;
the system is able to display, in the second display portion, a set of programming windows each representative of the listening spectrum of one of the onboard listening systems;
at least one of the programming windows includes at least one programming bar representative of a programmed listening range;
a contextual programming menu associated with a programming bar can be displayed by the operator by prolonged pressing on the programming bar;
the contextual programming menu is circular, and includes a plurality of zones selectable by one of the operator's fingers, relative to programming options of the listening system associated with the programming bar;
each display portion comprises a control menu, the control menus being positioned near opposite edges of the at least one touchscreen, each control menu being operable by a thumb of the operator;
the control menus are semicircular and each include a plurality of elements positioned along an arc of circle, each element being able to be actuated by pressure from one of the operator's fingers.
the control menu of the second portion comprises buttons able to control, by pressure from a user's finger, actions for creating a detection frequency, slowly or quickly modifying a detection frequency of the onboard system.
the carrier is an aircraft or a naval platform or a land vehicle.

Another aspect is a method for programming a situation analysis system onboard a carrier comprising at least one onboard listening system, implemented in an operator terminal comprising an information display capability, the method including:
displaying, in a first display portion of the display capability, tactical data on the environment of the carrier,
selection, by an operator, of at least one object of interest on the first display portion,
in response to the selection, displaying adjustment parameters for at least one onboard listening system in a second display portion of the display capability.

### BRIEF DESCRIPTION OF THE DRAWINGS

Other features and advantages of the described technology will emerge from the description thereof provided below, for information and non-limitingly, in reference to the appended figures, in which:

FIG. 1 is a perspective view of a terminal implemented in a listening system according to one embodiment;

FIG. 2 illustrates a usage scenario of the man-machine interface of the terminal of FIG. 1;

FIG. 3 diagrammatically illustrates a man-machine interface according to one embodiment; and

FIG. 4 illustrates a display example for selecting objects of interest from a list.

### DETAILED DESCRIPTION OF CERTAIN INVENTIVE EMBODIMENTS

The described technology will be described below in an embodiment in which the operator terminal is onboard a carrier of the aircraft, land vehicle or naval platform type, equipped with a situation analysis system including a plurality of listening systems able to provide situation analysis information for the environment of the carrier. The equipment of the listening systems of the situation analysis system is programmed by an operator to work in detection sectors configured by frequency ranges.

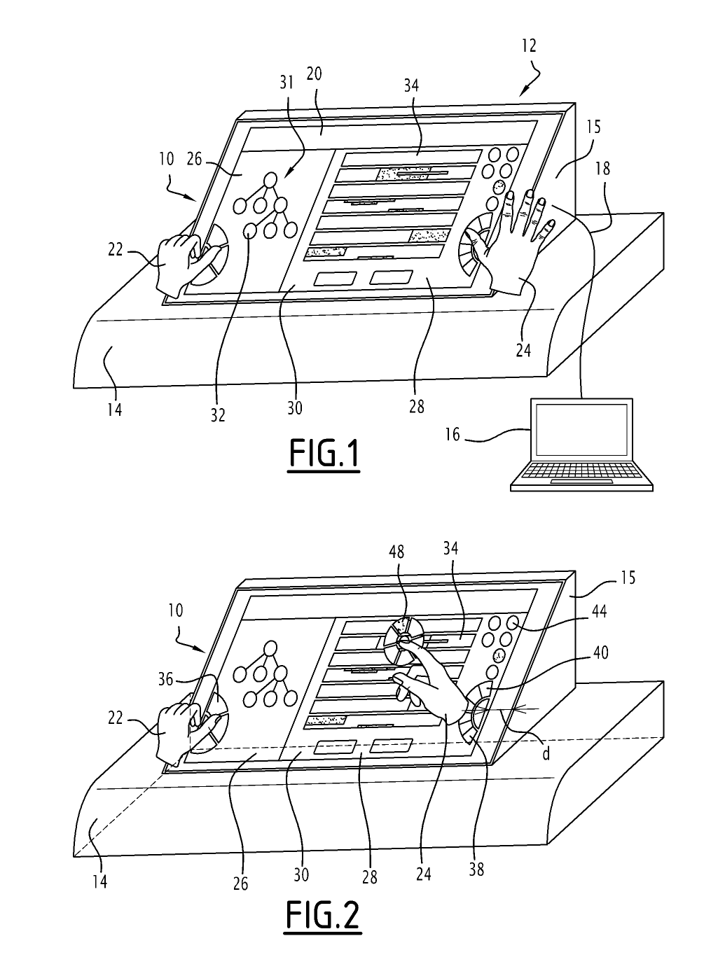

An operator terminal 10 of a mission system 12, which is part of a programming system according to one embodiment, is illustrated in FIGS. 1 and 2.

In this embodiment, the terminal 10 is fixed to the structure of the carrier (not shown) on a horizontal tablet 14, which is, for example, embedded in a dashboard and which allows an operator to rest his forearms so as to stabilize his position and avoid muscle fatigue during use of the terminal.

The lower edge of the terminal 10 is positioned in contact with the tablet 14.

In this embodiment, the terminal 10 is positioned in a position inclined by an angle of about 45° relative to the tablet 14, so as to make the display optimal and allow easier operation for an operator.

It may be desirable that the terminal 10 is fastened to the tablet 14 by a fastening member placed at the center of the terminal 10, so as to leave a free space behind the peripheral edges 15 of the terminal 10. Thus, a peripheral edge 15 of the terminal 10 is used as a fastening capability for the operator's hands, allowing the operator to grab onto the terminal 10 in case of jolts or sudden movements of the carrier.

It may be desirable that the vertical edges 15 of the terminal 10 have a thickness comprised between 1 cm and 3 cm, so as to facilitate gripping.

The terminal 10 is connected to a central processing unit 16, via a wired link 18. The central processing unit 16 is able to implement a software application for carrying out a method according to the described technology. The central processing unit 16 comprises a storage unit, making it possible to store data and parameters, for example, parameters of onboard equipment of the carrier of the mission system 12, and tactical data stored in a database.

The central processing unit 16 is shown in this embodiment in the form of a computer, but alternatively, the central processing unit 16 is implemented by a printed circuit, integrated into the terminal 10.

The terminal 10 includes a display capability or display 20. In at least one embodiment, the display capability 20 is formed by a touchscreen, allowing both the display of information and the entry of commands and information provided by an operator of the terminal.

Thus, FIGS. 1 and 2 show the hands 22, 24 of an operator interacting with the terminal 10.

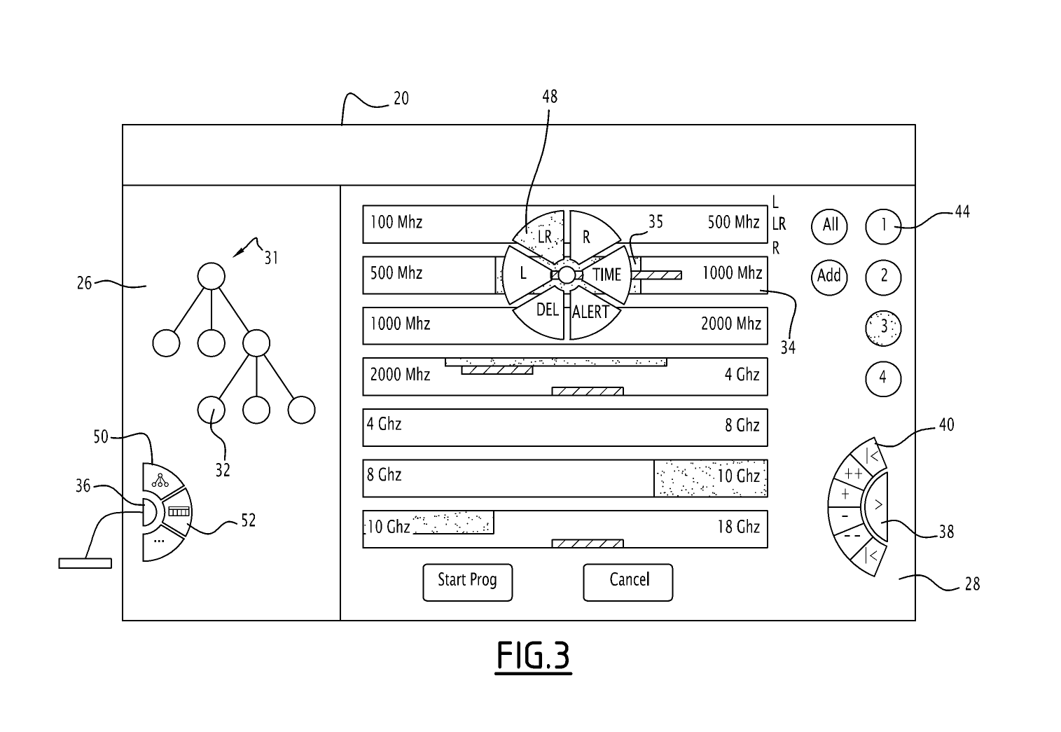

The touchscreen 20 is divided into two portions 26 and 28, separated by a separating hinge 30. The first portion 26, positioned to the left of the operator in the illustrated embodiment, is designed to display and select tactical environment data of the carrier, as explained in detail below in reference to FIG. 3. The tactical environment data available in the mission system is displayed in the form of a hierarchical tree structure 31 of selectable objects of interest 32.

The second portion 28 includes an assistance panel to adjust the operating parameters of the analysis system, which are parameters relative to the detection frequencies or frequency ranges of the transmitters in this embodiment. The panel of the second portion 28 includes a plurality of graphic objects, including programming windows 34, each representative of the complete spectrum of one of the onboard listening systems, therefore of all of the configurable listening ranges. Parameter values are automatically set based on the object(s) of interest selected by the operator.

As illustrated in FIGS. 1 and 2, each portion 26, 28 includes a control menu 36, 38, respectively. Each control menu 36, 38 is made up of several elements 40, easily selectable by the operator by tactile pressure from a finger, including by the user's thumb.

It may be desirable that each element 40 has a surface area at least equal to 1 square centimeter, thus allowing easy and precise manipulation by a user's thumb.

In one embodiment, the terminal 10 includes a fixing capability 42 for the operator's hands, for example a hollow recess on the rear face of the terminal 10, near the edge 15, allowing an operator to hold onto the terminal 10 and stabilize himself in case of sudden movements of the carrier.

It may be desirable that the control menus 36, 38 are positioned at the height of the fastening capability 42, such that the operator can fix himself by positioning the fingers of one hand, except the thumb, at the fixing capability 42, and act on a control menu by using his thumb, as illustrated in FIGS. 1 and 2.

The control menus 36, 38 are desirably semicircular, as illustrated in FIGS. 1 to 3. The elements 40 of these menus are, in this environment, positioned over an arc of circle, the center of which (not shown) is situated outside the screen, and the radius of which is chosen to correspond to the extension of the thumb for an average-sized hand, when the operator positions his hand gripping at the fixing capability 42, the forearm resting on the tablet 14. It may be desirable that the radius is comprised between 3 cm and 7 cm.

When the operator uses the terminal 10 according to at least one embodiment, he can therefore select menus and perform actions while remaining attached to the terminal 10.

Furthermore, the operator can remain fixed to the terminal 10 via one hand, and perform tactile commands through drag-drop operations or by prolonged pressing with a finger on a menu.

Thus, in one embodiment, the selection and adjustment are done by the operator by pressing a finger on an object of interest 32 of the first display portion 26 and sliding the finger kept bearing on the touchscreen 20 toward the second display portion 28, in order to trigger a display in the second portion 28 of graphic objects allowing the adjustment of the operating parameters of the object of interest.

In the second display portion 28, the operator can select parameters to adjust the selection buttons 44, desirably also situated near the edge 15 of the terminal 10 so as to facilitate their manipulation, as explained above.

It may be desirable that the distance d between an edge 15 of the terminal 10 and the touchscreen part of the closest display portion is smaller than or equal to 2 cm.

Optionally, one or more buttons 46 of the control pushbutton type, for example for opening/closing control windows 34, are provided on the rear face of the screen 20 or on the rims of the edge 15 of the screen 20, close enough to the fixing capability 42 to allow actuation by the operator's index finger when the other fingers of his hand, except the thumb, are engaged with the fixing capability 42.

According to one operating mode, when the operator presses in a prolonged manner using a finger on one of the programming windows 34 of the second portion 28, a contextual programming menu 48 relative to the equipment of the onboard listening system associated with this programming window 34 is displayed if the window 34 has associated programmed listening ranges 35, as explained in more detail below.

Alternatively, other tactile actions (click, double-click) on the programming windows 34 make it possible to show the contextual menu 48.

The use of the terminal 10 and its man-machine interface are described below in more detail, in reference to FIG. 3.

The tactical and strategic database is shown in a tree and hierarchical form 31. The database is stored in a storage unit associated with the central processing unit 16. The hierarchical tree structure 31 is made up of elements 32, which are objects of interest selectable by the operator. Selectable objects are representative of transmitters that one wishes to monitor. The system controls the onboard detectors to monitor the selected objects. The control menu 36 of the first display portion 26 makes it possible to apply filtering of the displayable elements in the hierarchical tree structure 31 (button 50), or to show a keyboard (button 52) for the subsequent entry of various commands.

The operator can select one or more objects of the hierarchical tree structure 31 through a predetermined gesture, for example a click or double-click on the touchscreen, or by maintained pressure by one or more fingers on the selected object(s).

Alternatively, the selection of the tactical database displayed in graphic form and the displayed objects 32 of the hierarchical tree structure is done using a keyboard entry, for example on a virtual keyboard, by selecting a carrier category and elements associated with the selected category.

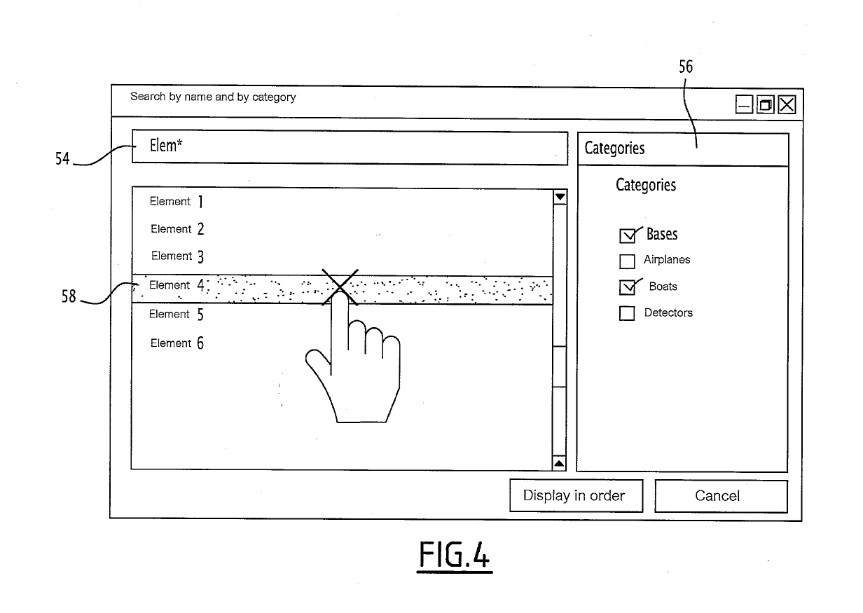

According to another alternative, a list of elements 54, filtered in one or more categories 56 of tactical data, is displayed in the first display portion. The operator has the possibility of selecting one or more elements 58 from the filtered list, as illustrated in the example of FIG. 4. In the example of the figure, two categories of the list of categories 56 are checked, and an element 58, called element 4, is selected by tactile selection by the operator. All of the objects of the selected categories 56 corresponding to the selected elements 58 are subsequently displayed in tree form in the structure 31.

When the operator selects an object 32, or a composite object made up of several simple objects 32, by pressure from one or more fingers and drags it toward the second portion 28 of the display capability 20, a set of programming parameters is illustrated in the programming windows 34 corresponding to the selected object in the second display portion 28. In the embodiment illustrated in FIG. 3, the addition of one or more objects modifies the programming windows 34 present, by adding programming bars 35, shown crosshatched in FIG. 3, corresponding to specific monitoring ranges.

When an object 32 is a composite object including several other so-called descending objects in the tree structure 31, the selection of the object 32 causes the display of the parameters of the onboard listening systems relative to all of these objects that are part of the composite object.

In one embodiment, the new programming bars 35 are signaled as new windows, for example by a blinking display for several seconds, or by another associated visual marker.

The current parameters associated with the selected objects of interest are automatically displayed, for example the list of intervals or frequency values to be detected. An automatic initialization of the values of the parameters is proposed, the operator subsequently having the possibility of modifying the values of the parameters using the interaction elements 40 of FIG. 3.

As illustrated in FIG. 3, when the configuration relates to a detection frequency, a frequency bar representative of the program frequency range is shown in a programming bar 35.

A contextual menu 48, which is desirably circular as shown in FIG. 3, appears when prolonged pressure is exerted on a programming bar 35. The contextual menu 48 proposes options relative to the programming of the onboard listening systems based on the selected object of interest 32, for example via a plurality of zones or buttons selectable by one of the operator's fingers.

For example, the contextual menu 48 allows the selection, when a right piece of equipment and left piece of equipment are present, located respectively on the right side and the left side of the carrier, of only the right piece of equipment (“R” button), only the left piece of equipment (“L” button), the set of both pieces of equipment (“L/R” button), a programming duration (“TIME” button), a configuration of the alerts (“ALERT” button), or the deletion of a program (“DEL” button).

For example, in one embodiment, the buttons of the programming contextual menu 48 can be selected by periodic pressing with one finger, while another of the user's fingers, for example the index finger as illustrated in FIG. 2, continues to press. Thus, the programming contextual menu 48 is displayed centered on the pressing finger (index finger in the example of FIG. 2), and each button can successively be selected using another of the operator's fingers. It may be desirable that the operator can rotate the elements of the menu 48 with an action of another finger, for example the thumb. Thus, the manipulation of the programming contextual menu 48 is particularly ergonomic and easy, which allows quick manipulation.

Thus, advantageously, a terminal according to at least one embodiment allows quick and intuitive entry, using a single hand, of operating parameters of the mission system, irrespective of the surrounding conditions (impacts, vibrations, etc.).

As illustrated in more detail in FIG. 3, the control menu 38 includes elements 40 allowing easy programming of the parameters.

If the parameters to be determined are frequencies or frequency ranges, the control menu 38 of the second portion makes it possible to command: the creation (“|<” button) of a new frequency, the slow modification (“+” and “−” buttons) or quick modification (“++” button and “−−” button) of the frequency, the creation of a range of predefined frequencies having the frequency determined with the |< button as start value and the value that will be defined via the “>|” button as end value.

Thus, the various graphic objects 34, 35, 40, 48 allow the adjustment of the operating parameters of the amorphous systems based on the selected object of interest 32.

Various other buttons allow the operator to program the situation analysis system, such as the “StartProg” and “Cancel” buttons for the beginning of programming and cancellation of programming. Of course, other alternatives that are not shown, including other control buttons, can be considered according to alternative embodiments of the described technology.

According to one alternative, the capability for displaying a terminal 10 are made up of two touchscreens, a first so-called main programming touchscreen as described in reference to FIGS. 1 and 2, and a second touchscreen, positioned above the first screen, inclined by approximately 77 degrees relative to the horizontal, the lower edge of the second screen being in contact with the upper edge of the main screen. Advantageously, the display surface is increased so as to improve user comfort. The second screen is desirably the same size as the main screen. According to one alternative, the second screen has different dimensions from the dimensions of the main screen.

According to another alternative, the terminal includes more than two screens.

Advantageously, a terminal according to at least one embodiment allows, due to the ergonomics of the division of the display capability into portions, rapid entry of complete programming parts of the listening system irrespective of the environment of the carrier.

Furthermore, owing to the control menus situated at the height of the capability for fixing the operator's hands, a terminal according to at least one embodiment allows a quick and reliable entry of the programming parameters in a constrained environment, in particular in case of strong impacts and vibrations.

While there have been shown and described and pointed out the fundamental novel features of the invention as applied to certain inventive embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplate. All such modifications and variations are within the scope of the invention as determined by the appended claims when interpreted in accordance with the breadth to which they are entitled.

1-15. (canceled)

16. A programming station for a situation analysis system onboard a carrier including at least one onboard listening system, comprising:
an operator terminal including an information display,
wherein the display comprises a first portion for displaying tactical data on the environment of the carrier and a second portion for displaying assistance in adjusting the operating parameters of at least one onboard listening system, the programming system including a capability for an operator to select at least one object of interest on the first display portion and a capability for automatically adjusting operating parameters of the least one onboard listening system on the selected object(s) of interest.

17. The system according to claim 16, wherein the display comprises at least one touchscreen, and wherein the selection is performed by the operator by pressing a finger on an object of interest of the first tactical data display portion and sliding the finger toward the second display portion, in order to initiate a display, in the second portion, of graphic objects making it possible to adjust the operating parameters of at least one onboard listening system based on the object of interest.

18. The system according to claim 16, wherein the system is able to display, in the first display portion, a set of tactical data in the form of objects of interest represented in a hierarchical tree structure.

19. The system according to claims 16, wherein the system is able to display, in the first display portion, a list of selectable objects, filtered as a function of tactical data categories.

20. The system according to claim 16, wherein the system is able to display, in the second display portion, a set of programming windows each representative of the listening spectrum of one of the onboard listening systems.

21. The system according to claim 20, wherein at least one of the programming windows includes at least one programming bar representative of a programmed listening range.

22. The system according to claim 21, wherein a contextual programming menu associated with a programming bar can be displayed by the operator by prolonged pressing on the programming bar.

23. The system according to claim 22, wherein the contextual programming menu is circular, and includes a plurality of zones selectable by one of the operator's fingers, relative to programming options of the listening system associated with the programming bar.

24. The system according to claim 17, wherein each display portion comprises a control menu, the control menus being positioned near opposite edges of the touchscreen, each control menu being operable by a thumb of the operator.

25. The system according to claim 24, wherein the control menus are semicircular and each include a plurality of elements positioned along an arc of circle, each element being able to be actuated by pressure from one of the operator's fingers.

26. The system according to claim 25, wherein the control menu of the second portion comprises buttons able to control, by pressure from a user's finger, actions for creating a detection frequency, slowly or quickly modifying a detection frequency of the onboard system.

27. The system according to claim 1, wherein the carrier is one of an aircraft, a naval platform and a land vehicle.

28. A method of programming a situation analysis system onboard a carrier comprising at least one onboard listening system, implemented in an operator terminal comprising an information display, the method comprising:
displaying, in a first display portion of the display, tactical data on the environment of the carrier;
selecting, by an operator, of at least one object of interest on the first display portion; and
in response to the selection, displaying adjustment parameters for at least one onboard listening system in a second display portion of the display.

29. The method of programming a situation analysis system onboard a carrier according to claim 28, wherein the selection is performed by the operator by pressing a finger on the object of interest of the first tactical data display portion and sliding a finger toward the second display portion, and in that after dragging the object of interest, at least one graphic object making it possible to adjust the operating parameters of at least one onboard listening system is displayed in the second display portion.

30. The method of programming a situation analysis system onboard a carrier according to claim 13, wherein the tactical data are displayed in the form of a hierarchical tree structure of objects of interest, and wherein the selecting of the object of interest causes the displaying of the adjustment parameters relative to the set of objects directly descending, in the tree structure, from the selected object of interest.
